(19) United States
(12) Patent Application Publication
(10) Pub. No.: US 2009/0147106 A1
(43) Pub. Date: Jun. 11, 2009

(54) Image capturing apparatus and electronic information device

(76) Inventors: Yasunori Sakamoto, Nara (JP); Nobuyoshi Yanagisawa, Osaka (JP)

Correspondence Address: Edwards Angell Palmer & Dodge LLP, P.O. Box 55874, Boston, MA, 02205, US

(21) Appl. No.: 12/292,399

(22) Filed: Nov. 18, 2008

(30) Foreign Application Priority Data
Nov. 19, 2007 (JP) 2007-299801

(51) Int. Cl. H04N 9/68; H04N 5/228

(52) U.S. Cl. 348/234; 348/222.1; 348/E05.031; 348/E09.053

(57) ABSTRACT

An image capturing apparatus according to the present invention includes: an image capturing section for forming an image of a subject via an optical system; a signal processing section for obtaining image center position information for an image data from the image capturing section to perform a shading correction; an image center position information extracting section for importing an image data from the image capturing section to obtain the image center position information; and a shading correcting section for performing a shading correction process using the image center position information as shading center position information so that the amount of light does not decrease at a peripheral portion of a captured image.

This nonprovisional application claims priority under 35 U.S.C. §119(a) to Patent Application No. 2007-299801 filed in Japan on Nov. 19, 2007, the entire contents of which are hereby incorporated by reference.

### BACKGROUND OF THE INVENTION

1. Field of the Invention

The present invention relates to an image capturing apparatus, such as a camera module, for performing a photoelectric conversion on and capturing an image light from a subject, and an electronic information device, such as a digital camera (e.g., digital video camera and digital still camera), an image input camera (e.g., car-mounted back view camera), a scanner, a facsimile machine, and a camera-equipped cell phone device, having the image capturing apparatus as an image input device used in an image capturing section thereof.

2. Description of the Related Art

The camera module described above, which is a conventional image capturing apparatus, is configured by combining a semiconductor image sensor, such as a CCD-type image sensor and a CMOS-type image sensor, a DSP (digital signal processor), which is a signal processing section for signal-processing image data outputted from the semiconductor image sensor, and an optical lens for forming an image on a light receiving image capturing area of the semiconductor image sensor.

FIG. 17 is a longitudinal cross sectional view schematically illustrating an exemplary essential structure of a conventional camera module.

As illustrated in FIG. 17, a conventional camera module 100 includes: an image sensor 102 attached to a substrate 101; a lens holder 106, where a lens unit 104 having a lens 103 attached thereon is attached to an upper portion, an image sensor 102 is accommodated in a lower portion, and an infrared ray (IR) cut filter 105 for cutting infrared rays from incident light from the lens 103 is positioned across the image sensor 102 and the lens 103; and a DSP 107, which is a signal processing section attached to the substrate 101 at a vicinity of the lens holder 106. The DSP 107 may also be built in the lens holder 106, and the semiconductor image sensor 102 and the DSP 107 may be configured in one chip. The lens unit 104 has a screw thread formed on its outer circumference portion, and the outer circumference portion is screwed into the lens holder 106 to adjust a focal distance of the lens 103 in a vertical direction with respect to the semiconductor image sensor 102.

With the structure described above, an image of an incident light is formed through an optical lens of the lens unit 104 on a light receiving image capturing area of the semiconductor image sensor 102. Subsequently, image data captured by the image sensor 102 is outputted, and the image data is processed into an image data required by a user by the DSP 107 with a color interpolating process, a color tone correcting process and the like. The image data is outputted to an outer terminal after the signal processing.

The lens 103 of the lens unit 104 is characterized in that an image becomes darker from the center portion of an image to a peripheral portion of the image, and therefore, an image obtained without signal processing has a shading characteristic, which is inconvenient for a user, where the image becomes darker from the center to the periphery of a display screen. An image having substantially equal luminance in the entire image can be obtained by an image process, such as a shading correcting process, by the DSP 107. The shading correcting process is for performing a correcting process on an image from the center to the periphery concentrically such that the luminance in the periphery has substantially the same luminance level as the luminance in the center.

In general, unevenness in luminance may occur in an image obtained by a camera module (image capturing apparatus) used for a television camera, video camera and the like, due to the characteristic of the image capturing element, the lens and the like. Because of this, shading correction is performed to correct an image by multiplying the image by a correction coefficient according to each position of a captured image. The unevenness in luminance in the captured image occurs concentrically in a direction from the middle to the outer circumference side of the image. Therefore, the shading correction is performed in the prior art by multiplying a correction coefficient with a middle portion of the image as the center.

In addition, Reference 1 proposes an image capturing apparatus for performing a camera shake compensation at the same time when a correction for the deterioration of an image quality, such as chromatic aberration, is performed by enlarging or reducing the size of images having respective colors.

However, inconvenience may be experienced with the conventional method according to Reference 1. That is, the shading correction may not be appropriately performed on the unevenness in luminance occurred due to the shape of a shutter or a closing mechanism because the center position of the distribution of the unevenness in luminance may be different from the center of the image depending on the shape or the mechanism, or the center position for the correction may be different depending on the shutter speeds.

Thus, Reference 2 discloses how to obtain a captured image without unevenness in the amount of light for any shutter speed, even when the center of the luminance is shifted in accordance with the shutter speed.

FIG. 18 is a block diagram schematically illustrating an exemplary essential structure of a conventional camera module disclosed in Reference 2.

In FIG. 18, a conventional camera module 200 performs a predetermined signal process on a captured signal of a subject 203 obtained by a CCD (Charge Coupled Device) 202 via a lens 201. Subsequently, the camera module 200 stores the signal in a SDRAM (Synchronous Dynamic Random Access Memory) 204 and outputs the signal as a picture signal to a monitor 205 or a flash memory 206. The lens 201 performs a predetermined optical change on an incident light from the subject 203 by focusing adjustment and zooming adjustment. A reflected light of the subject 203 optically changed by the lens 201 is formed into an image on an image capturing area of the CCD 202 via a mechanical shutter 207. The CCD 202 outputs the reflected light of the subject 203 as an image capturing signal.

The conventional camera module 200 includes: an amplifier 208 for amplifying the image capturing signal obtained from the CCD 202 so that later signal processes can be performed; an A/D converting section 209 for converting the image capturing signal provided from the amplifier 208 from analog to digital; and a shading correcting section 210 for performing a correcting process of luminance on the image capturing signal, which is digitalized by the A/D converting section 209, and correcting the shading of the image capturing signal.

A CPU 211 functions as a center position correcting section for changing the center position of the shading correction by the shading correcting section 210 in accordance with the shutter speed of the mechanical shutter 207 that switches the timings of exposure for capturing an image by the CCD 202.

As illustrated in FIG. 19, a double-leaf mechanical shutter 207 is operated to open and close in an opening and closing direction H, which correspond to a direction of the long side of the rectangular CCD 202, so that the amount of a reflected light of the subject 203, which enters a CCD image capturing surface 202a of the CCD 202, decreases at a peripheral portion of the lens 201 or an outer circumference portion in the opening and closing direction of the mechanical shutter 207, of the CCD image capturing surface 202a, illustrated as a light amount characteristic L.

The shading correcting section 210 is provided to correct the decrease of the amount of the light in the peripheral portion of the lens 201. The shading correcting section 210 has a gain characteristic as illustrated by a shading correcting characteristic P, which is a reverse characteristic from the light amount characteristic L, concentrically as the middle portion of the captured image as the center. The shading correcting section 210 functions to apply the gain characteristic for an obtained image data.

FIG. 20 is a block diagram schematically illustrating an exemplary essential structure of a conventional camera module disclosed in Reference 3.

In FIG. 20, a conventional camera module (image capturing apparatus) 300 includes: a lens (optical element) 301; a CCD sensor 302; an analog front end (AFE) 303; an optical axis adjusting section 304; and a video amplifier 305. The lens 301 is provided for a camera case 306; and the CCD 302, the AFE 303, the optical axis adjusting section 304 and the video amplifier 305 are built in the camera case 306. A picture captured by the camera module 300 is displayed on a monitor (display section) 307.

The lens 301 is an optical element for forming an image of a light from a subject in the CCD 302. The lens 301 includes a focusing function and the like.

The CCD 302 includes an image capturing area having a plurality of pixels arranged in a matrix thereon. A subject light enters and an optical image is formed on the image capturing area. The CCD 302 converts the optical image into an electric signal and outputs the electric signal as an analog image signal.

The CCD 302 is used as a solid-state image capturing element, however, a CMOS image sensor may also be used.

The AFE 303 converts an analog signal obtained from the CCD 302 into a digital signal. The AFE 303 performs amplification, noise reduction and the like for the analog signal obtained from the CCD 302.

The optical axis adjusting section 304 is for adjusting the optical axis of the CCD 302 based on a picture signal (image capturing signal) outputted from the CCD 302, and is a DSP that is configured of an LSI (large-scale integrated circuit), for example. Although not shown in the figure, the optical axis adjusting section 304 also includes a CPU (central processing unit) for performing a variety of arithmetic processing in accordance with a program, a ROM for storing a program, and a RAM for storing data and the like that are being processed. With such a structure, the optical axis adjusting section 304 includes a function for controlling the overall camera module 300 in addition to the optical axis adjusting process.

The video amplifier 305 is for converting a signal outputted from the optical axis adjusting section 304 into a picture signal to be displayed on the monitor 307 as a picture. That is, the video amplifier 305 generates a picture signal based on standards on the picture signal. For example, the NTSC (National Television System Committee) method is standardized as the television broadcasting signal in Japan. Therefore, the video amplifier 305 converts the signal outputted from the optical axis adjusting section 304 into a picture signal in the NTSC method.

In the camera module 300, photoelectric conversion is performed on an incident light that has passed the lens 301 by the CCD 302. An analog image signal outputted from the CCD 302 is converted into a digital signal by the AFE 303. Necessary band data is retrieved from the digital signal outputted from the AFE 303 by a picture signal processing circuit (which will be described later) of the optical axis adjusting section 304, and the digital signal is again converted into an analog signal.

As a result, when the converted picture signal is outputted to the monitor 307, such as a liquid crystal display (LCD), via a picture signal line 308, the picture is displayed on the monitor 307.

Herein, in the camera module 300, if the optical axis of the lens 301 does not match the optical axis of the CCD 302 (which means that a “deviation of optical axis” is occurring), the subject captured by the CCD 302 will not be displayed accurately. Therefore, it is necessary to correct the deviation in the optical axis within an allowable range.

Hence, the camera module 300 is to perform an optical axis adjusting mode when recognizing a test pattern of an optical axis chart 309.

The optical chart 309, which is a test pattern, is a special subject for allowing the camera module 300 to perform the optical axis adjusting mode. The optical chart 309 in FIG. 20 includes: center lines 309a for indicating respective centers of the optical axis chart 309 in a horizontal direction (X direction) and a vertical direction (Y direction); and four illustrations 309b, each of which is different from each other in at least one of the illustration's shape and color component. Each of the center lines 309a is an optical axis line for adjusting the optical axis, and each of the illustrations 309b is for characterizing the optical axis chart 309. That is, the illustrations 309b are illustrated on the optical chart 309 so that the optical chart 309 becomes a special subject for allowing the optical axis adjusting mode to be performed.

When the optical chart 309 is positioned at a predetermined position and a subject captured by the CCD 302 is recognized as the optical chart 309, the optical axis adjusting section 304 performs the optical axis adjusting mode where all the picture signals are read out from an effective image capturing surface and picture signals equivalent to a practical image capturing surface are cut out from all the picture signals of the effective image capturing surface.

Reference 1: Japanese Laid-Open Publication No. 2003-255424

Reference 2: Japanese Laid-Open Publication No. 2006-165894

Reference 3: Japanese Laid-Open Publication No. 2007-134999

### SUMMARY OF THE INVENTION

According to the prior art in FIG. 17 described above and in References 1 to 3 described above, the center of a concentric circle for the shading correction is generally at the center of the image. Therefore, it is desirable that the center of a light receiving area of the image sensor matches the optical center of a lens. However, there may be a case, for example, where the image sensor 102 may deviate from the substrate 101 in a plane direction at the time of attachment, or the image sensor 102 may deviate from the lens 103 in a plane direction when the lens 103 is accommodated in the lens unit 104, which is subsequently screwed into the lens holder 106, and the lens holder 106, which accommodates the image sensor 102 therein, is attached to the substrate 101. Thus, some deviation may occur in X and Y directions (plane direction) upon assembling, and the center of the light receiving area of the image sensor 102 and the optical center of the lens 103, may not necessarily correspond to each other depending on the accuracy of the assembling. As a result, the center position of the shading characteristic of an image due to the lens 103 deviates from the center position of the correction (center of the image sensor 102), and the deviated center position becomes most bright as illustrated in FIG. 21. In addition, a deviation also occurs in the shading (output of the image sensor), and the correction by the DSP is not performed at the center position of the standard image. Finally, an image having unbalanced luminance therein after the shading correction is outputted and is displayed on a display screen.

In particular, Reference 2 described above is for changing the center position of the shading correction in accordance with a shutter speed, and such matter is different from the present invention for defining the center of an image for the shading correction. Further, according to Reference 3 described above, it is required to set the test pattern of the optical chart 309 in advance and actually display it on a display section, and further, it is required for the optical axis adjusting section 304 to adjust the optical axis such that the optical deviation of the center line 309a is corrected within an allowable range. If the allowable range is set roughly, the optical axis will also be adjusted roughly. If the allowable range is set strictly, the adjustment for the optical axis will also be difficult. Such matter is merely to actually display the test pattern to adjust the optical axis, whereas the present invention is to define the center of an image for the shading correction. As a result, more man-hours are required for the adjustment of the optical axis.

The present invention is intended to solve the conventional problems described above. The objective of the present invention is to provide an image capturing apparatus, which performs the shading correction at the center of an image so as not to require any improvement on the accuracy for correcting deviation of a center of an optical axis due to the assembling, thereby obtaining a finer image with the shading correction; and an electronic information device, such as a camera-equipped cell phone device, having the image capturing apparatus used as an image input device in an image capturing section thereof.

An image capturing apparatus according to the present invention includes: an image capturing section for forming an image of a subject via an optical system; and a signal processing section for obtaining image center position information for image data from the image capturing section to perform a shading correction, thereby achieving the objective described above.

Preferably, an image capturing apparatus according to the present invention further includes: an image center position information extracting section for importing an image data from the image capturing section to obtain the image center position information; and a shading correcting section for performing a shading correction process using the image center position information as shading center position information so that the amount of light does not decrease at a peripheral portion of a captured image.

Still preferably, in an image capturing apparatus according to the present invention, the image capturing section is attached to a substrate; a lens holder, to which a focusing lens of the optical system is attached, accommodates the image capturing section inside and is attached to the substrate; and the signal processing section is attached near the lens holder on the substrate.

Still preferably, in an image capturing apparatus according to the present invention, an infrared ray cut filter for cutting infrared rays from incident light from the focusing lens is positioned across the image capturing section and the focusing lens.

Still preferably, in an image capturing apparatus according to the present invention, the image capturing section is a light receiving section, which has an image capturing area having a plurality of light receiving sections arranged therein in a matrix for performing a photoelectric conversion on a subject light.

Still preferably, in an image capturing apparatus according to the present invention, the image capturing apparatus is provided with an A/D converting section for converting an analog image capturing signal from the light receiving section to a digital data, and the digital data from the A/D converting section is used as the image data to extract the image center position information.

Still preferably, in an image capturing apparatus according to the present invention, the image center position extracting section includes: an image data importing section for importing an image data from the image capturing section; a horizontal center coordinate extracting section for extracting a horizontal center coordinate of the image center position information from an image data imported by the image data importing section; and a vertical center coordinate extracting section for extracting a vertical center coordinate of the image center position information from the image data imported by the image data importing section.

Still preferably, in an image capturing apparatus according to the present invention, the image center position information extracting section further includes a coordinate information memory controlling section for storing a coordinate value of each center coordinate extracted from the horizontal center coordinate extracting section and the vertical center coordinate extracting section, in a storing section as the image center position information.

Still preferably, in an image capturing apparatus according to the present invention, the image data importing section imports a data of an overall picture or a middle portion of the picture of an image data from the image capturing section.

Still preferably, in an image capturing apparatus according to the present invention, the middle portion of the image of the image data is an image middle area, which includes at least two inner-most luminance change point coordinates of an X direction and a Y direction when a resolving power of a luminance value is lowered for one line of each picture in the X direction and the Y direction.

Still preferably, in an image capturing apparatus according to the present invention, each of the horizontal center coordinate extracting section and the vertical center coordinate extracting section includes: a luminance value extracting process section for extracting a luminance value of one line of a picture; a luminance value resolving power lowering process section for lowering a resolving power of the extracted luminance value of one line in a picture; a luminance changing point extracting process section for extracting two inner-most luminance changing point coordinates of the luminance value of one line in a picture; and a shading center coordinate extracting process section for extracting the center coordinates of the two inner-most luminance changing point coordinates as a shading center coordinates.

Still preferably, in an image capturing apparatus according to the present invention, the luminance value extracting process section extracts, from a digital image data from the image capturing section, a luminance value of one line in a X direction at a center portion in a Y coordinate direction as well as a luminance value of one line in a Y direction at a center portion in an X coordinate direction.

Still preferably, in an image capturing apparatus according to the present invention, the luminance value resolving power lowering process extracts a luminance value data of one line in an X direction, where a predetermined lower number of bits are removed from a digital image data of the luminance value of one line in the X direction and the luminance value resolving power is reduced, and a luminance value data of one line in a Y direction, where a predetermined lower number of bits are removed from a digital image data of the luminance value of one line in the Y direction and the luminance value resolving power is reduced.

Still preferably, in an image capturing apparatus according to the present invention, the luminance changing point extracting process section consecutively performs an integral process on a luminance value data of one line having a reduced luminance value resolving power so as to extract changing points, and obtains two inner-most changing point coordinates of changing points of the luminance value data.

Still preferably, in an image capturing apparatus according to the present invention, the shading center coordinate extracting process section obtains center coordinates of an image, X0 and Y0, of changing point coordinates X1, X2 and Y1, Y2 from equations X0=X1+(X2−X1)/2 and Y0=Y1+(Y2−Y1)/2, using the two inner-most changing point coordinates, X1, X2 and Y1, Y2.

Still preferably, in an image capturing apparatus according to the present invention, the shading correction processing section includes: a coordinate information reading section for reading out each coordinate value of image center position information stored in the storing section; a shading correction processing section for performing a shading correction process using each coordinate value of the image center position information from the coordinate information reading section; and an image data outputting section for outputting an image data after the shading correction process.

Still preferably, in an image capturing apparatus according to the present invention, the shading correcting process is at least either a luminance shading correcting process or a color shading correcting process.

Still preferably, in an image capturing apparatus according to the present invention, the image center position information extracting section detects optical axis center position information from an even image data from the image capturing section as the image center position information.

Still preferably, in an image capturing apparatus according to the present invention, the image capturing apparatus is a camera module.

An electronic information device according to the present invention has the image capturing apparatus according to the present invention used as an image input device in an image capturing section.

The functions of the present invention having the structures described above will be described hereinafter.

The present invention includes an image capturing section for capturing an image of a subject via an optical system, and a signal processing section for obtaining image center position information with regard to an image data from the image capturing section to process a shading correction. As a result, the shading correction is performed at the center of an image so that no improvement is required on the accuracy for correcting deviation of a center of an optical axis due to the assembling, and a finer image with the shading correction can be obtained.

According to the present invention as described above, the shading correction is processed by obtaining image center position information with regard to an image data from the image capturing section, and therefore, no improvement is required on the accuracy for correcting deviation of a center of an optical axis due to the assembling, and a finer image with the shading correction can be obtained.

These and other advantages of the present invention will become apparent to those skilled in the art upon reading and understanding the following detailed description with reference to the accompanying figures.

### BRIEF DESCRIPTION OF THE DRAWINGS

FIG. 1 is a block diagram illustrating an exemplary essential structure of a camera module according to Embodiment 1 of the present invention.

FIG. 2 is a block diagram illustrating an exemplary essential structure of an input signal processing section and a shading correction processing section in FIG. 1.

FIG. 3 is a flow chart illustrating one example of an image center coordinate extracting process by a horizontal shading center coordinate X extracting section and vertical shading center coordinate Y extracting section in FIG. 2.

FIG. 4 is a diagram of a picture illustrating a single color output image imported by an image data importing section in FIG. 2.

FIG. 5 is a diagram of a luminance value characteristic curve, illustrating an example of one line luminance value extracting process by a horizontal shading center coordinate X extracting section or a vertical shading center coordinate Y extracting section in FIG. 2.

FIG. 6 is a diagram of a luminance value characteristic, illustrating an example of one line luminance value resolving power lowering process by a horizontal shading center coordinate X extracting section or a vertical shading center coordinate Y extracting section in FIG. 2.

FIG. 7 is a diagram of a luminance value characteristic, illustrating an example of one line luminance change point coordinate X1 and X2 extracting process by a horizontal shading center coordinate X extracting section or a vertical shading center coordinate Y extracting section in FIG. 2.

FIG. 8 is a plan view illustrating an example of one line luminance change point coordinate X1 and X2 extracting process by a horizontal shading center coordinate X extracting section or a vertical shading center coordinate Y extracting section in FIG. 2.

FIG. 9 is a diagram of a shading characteristic, illustrating a shading characteristic by a shading correction processing section in FIG. 1.

FIG. 10 is a block diagram illustrating an exemplary essential structure of a camera module according to Embodiment 2 of the present invention.

FIG. 11 is a block diagram illustrating a specific structural example of an input signal processing section and a shading correction processing section in FIG. 10.

FIG. 12 is a flow chart illustrating one example of a shading center coordinate extracting process by a horizontal shading center coordinate X extracting section and a vertical shading center coordinate Y extracting section in FIG. 11.

FIG. 13 is a diagram of a picture, illustrating a single color output image imported by an image data importing section in FIG. 11.

FIG. 14 is a diagram of a luminance value characteristic curve, illustrating an example of one line luminance value extracting process by a horizontal shading center coordinate X extracting section or a vertical shading center coordinate Y extracting section in FIG. 11.

FIG. 15 is a diagram of a luminance value characteristic, illustrating an example of one line luminance value resolving power lowering process by a horizontal shading center coordinate X extracting section or a vertical shading center coordinate Y extracting section in FIG. 11.

FIG. 16 is a block diagram illustrating an exemplary diagrammatic structure of an electronic information device as Embodiment 4 of the present invention, having the sensor module according to any of Embodiments 1 to 3 of the present invention as an image input device used in an image capturing section thereof.

FIG. 17 is a longitudinal cross sectional view schematically illustrating an exemplary essential structure of a conventional camera module.

FIG. 18 is a block diagram schematically illustrating an exemplary essential structure of a conventional camera module disclosed in Reference 2.

FIG. 19 is a diagram illustrating a shading correction characteristic in accordance with a light amount characteristic due to a mechanical shutter.

FIG. 20 is a block diagram schematically illustrating an exemplary essential structure of a conventional camera module disclosed in Reference 3.

FIG. 21 is a diagram of a shading characteristic, illustrating a shading characteristic when the center of a light receiving area is different from the center of a shading characteristic.

1, 1A, 1B camera module
2 focusing lens
3 image sensor
4 DSP (signal processing section)
41 input signal processing section
411 image data importing section
412 horizontal shading center coordinate X extracting section
413 vertical shading center coordinate Y extracting section
414 coordinate information memory controlling section
42 memory
43 register
44 shading correction processing section
441 coordinate information reading section
442 shading correction processing section
443 image data outputting section
31 light receiving element
32 A/D converting section
50 electronic information device
51 memory section
52 display section
53 communication section
54 image output section

### DESCRIPTION OF THE PREFERRED EMBODIMENTS

Hereinafter, Embodiments 1 to 3 of the image capturing apparatus according to the present invention applied for a camera module will be described in detail with reference to the attached figures. Further, an electronic information device having the camera module according to any of Embodiments 1 to 3 of the present invention as an image input device in an image capturing section thereof will be described in detail as Embodiment 4 with reference to the attached figures.

### Embodiment 1

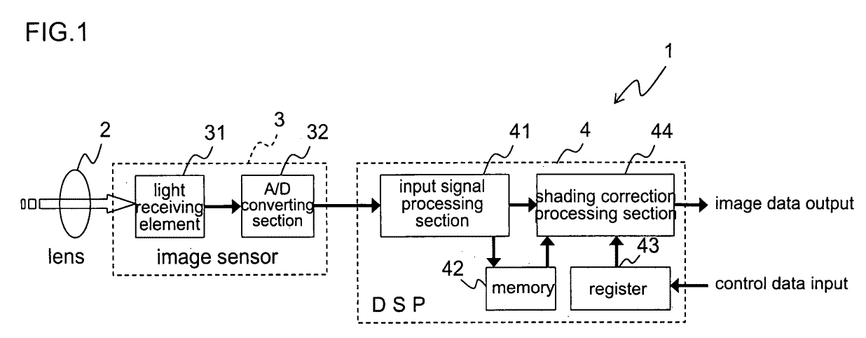

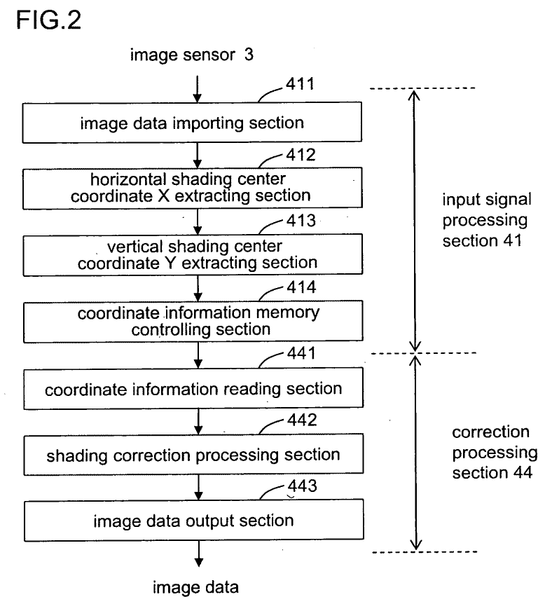

FIG. 1 is a block diagram illustrating an exemplary essential structure of a camera module according to Embodiment 1 of the present invention. FIG. 2 is a block diagram illustrating an exemplary essential structure of an input signal processing section and a shading correction processing section in FIG. 1.

In FIG. 1, a camera module 1 according to Embodiment 1 includes: an image sensor 3 functioning as an image capturing section for performing a photoelectric conversion on an incident light originated from a subject via a focusing lens 2 to capture an image; and a DSP 4 functioning as a signal processing section for obtaining image center position with regard to an image data from the image sensor 3 to process a shading correction.

The image sensor 3 includes: a light receiving element 31, which has an image capturing area having a plurality of light receiving sections arranged therein in a matrix for performing a photoelectric conversion on a subject light; and an A/D converting section 32 for converting an image capturing signal, which is an analog signal from the light receiving element 31, into a digital data.

The DSP 4 includes: an input signal processing section 41 functioning as an image center position information extracting means for performing a predetermined arithmetic processing using a digital data (image data) from the A/D converting section 32 as an input to obtain the center position of an image; a memory 42 for temporarily storing the center position data of the image processed at the input signal processing section 41; a register 43 for inputting a control data for a shading correction; and a shading correction processing section 44 functioning as a shading correction processing means for performing a shading correction process in such a manner to compensate for a decrease of the amount of light in a peripheral portion of a captured image, using the center position data of an image from the memory 42 and a control data for a shading correction from the register 43 and further, using image center position information including the center position data of an image as shading center position information.

The input signal processing section 41 includes: an image data importing section 411 functioning as an image data importing means for importing an image data from the image sensor 3; a horizontal shading center coordinate X extracting section 412 functioning as a horizontal center coordinate extracting means for extracting a horizontal coordinate (X coordinate) of shading center coordinates (X, Y), which correspond to an image center position data, from the image data imported by the image data importing section 411; a vertical shading center coordinate Y extracting section 413 functioning as a vertical center coordinate extracting means for extracting a vertical coordinate (Y coordinate) of the shading center coordinates (X, Y); and a coordinate information memory controlling section 414 for storing each coordinate value of the shading center coordinates (X, Y), which is extracted at the horizontal shading center coordinate X extracting section 412 and vertical shading center coordinate Y extracting section 413, as image center position data in the memory 42.

The image center position information extracting means is configured of the image data importing section 411, the horizontal shading center coordinate X extracting section 412, and the vertical shading center coordinate Y extracting section 413. The image center position information extracting means imports an image data from the light receiving element 31, extracts a horizontal center coordinate of the image center position information from the imported image data, and extracts a vertical center coordinate of the image center position information from the imported image data.

Each of the horizontal center coordinate extracting means and the vertical center coordinate extracting means includes: a luminance value extracting process section (not shown) for extracting a luminance value of one line in a picture; a luminance value resolving power lowering process section (not shown) for lowering a resolving power of the extracted luminance value of one line in a picture; a luminance changing point extracting process section (not shown) for extracting two inner-most luminance changing point coordinates of the luminance value of one line in a picture that has lowered the resolving power; and a shading center coordinate extracting process section (not shown) for extracting the center coordinates of the two inner-most luminance changing point coordinates as a shading center coordinates.

The luminance value extracting process section extracts, from a digital image data from the light receiving element 31, a luminance value of one line in the x direction at the center portion in the Y coordinate direction as well as a luminance value of one line in the Y direction at the center portion in the X coordinate direction.

The luminance value resolving power lowering process section extracts a luminance value data of one line in the X direction, where a predetermined lower number of bits are removed from a digital image data of the luminance value of one line in the X direction and the luminance value resolving power is reduced, and extracts a luminance value data of one line in the Y direction, where a predetermined lower number of bits are removed from a digital image data of the luminance value of one line in the Y direction and the luminance value resolving power is reduced.

The luminance changing point extracting process section consecutively performs an integral process on the luminance value data of one line with a reduced luminance value resolving power to extract changing points, and obtains the two inner-most changing point coordinates of the changing points of the luminance value data.

The shading center coordinate extracting process section obtains the center coordinates of the image, X0 and Y0, of changing point coordinates X1, X2 and Y1, Y2 from the equations X0=X1+(X2−X1)/2 and Y0=Y1+(Y2−Y1)/2, using the two inner-most changing point coordinates, X1, X2 and Y1, Y2.

The shading correction processing section 44 includes: a coordinate information reading section 441 for reading out each coordinate value of shading center coordinates (X, Y) stored in the memory 42 by the coordinate information memory controlling section 414; a shading correction processing section 442 for performing a shading correction process using each coordinate value of the shading center coordinates (X, Y) from the coordinate information reading section 441; and an image data outputting section 443 for outputting an image data after the shading correction process.

With the structure described above, the operation will be described hereinafter.

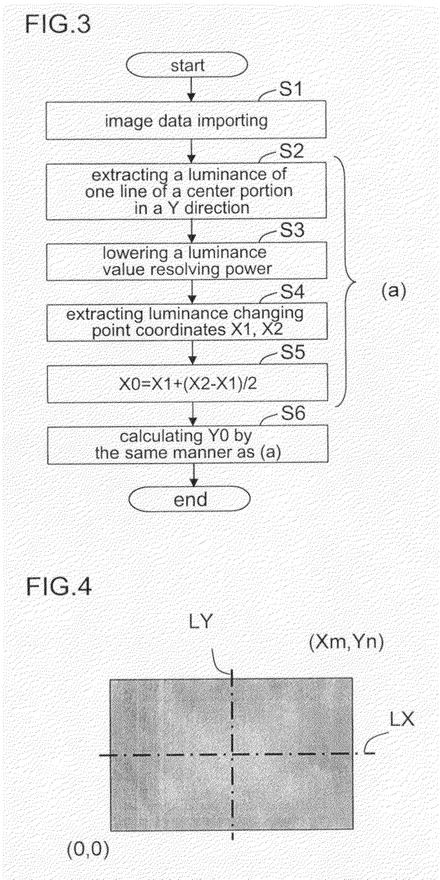

FIG. 3 is a flow chart illustrating one example of an image center coordinate extracting process by the horizontal shading center coordinate X extracting section 412 and vertical shading center coordinate Y extracting section 413 in FIG. 2.

First, in an image importing process of the step S1, an image data is imported from the image sensor 3 as single color output image information, which starts from the coordinates (X0, Y0) to the coordinates (Xm, Ym) as illustrated in FIG. 4, the color being typically white.

Next, in a luminance value extracting process of one line in the X direction of the step S2, the horizontal shading center coordinate X extracting section 412 extracts a luminance value of one line LX in the X direction at the center portion in the Y coordinate direction as illustrated in FIG. 4 from a digital image data from the image sensor 3 by one line in the transverse direction (row direction) as illustrated in FIG. 5.

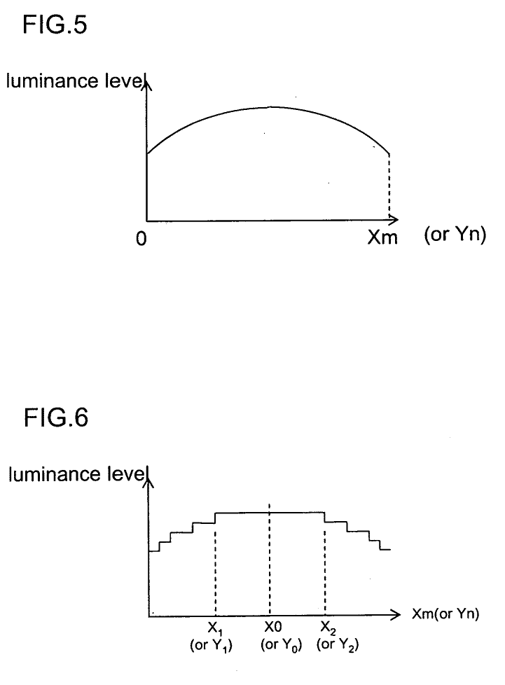

Subsequently, in a luminance value resolving power lowering process of the step S3, the horizontal shading center coordinate X extracting section 412 removes lower number bits (lower 2 bits or 4 bits of 256 gradient of 8 bits, herein) from 8-bit digital image data, for example, of the luminance value of one line in the X direction in FIG. 5 to reduce the luminance value resolving power and a change of a certain width. Further, the horizontal shading center coordinate X extracting section 412 extracts a luminance value data of one line as illustrated in FIG. 6.

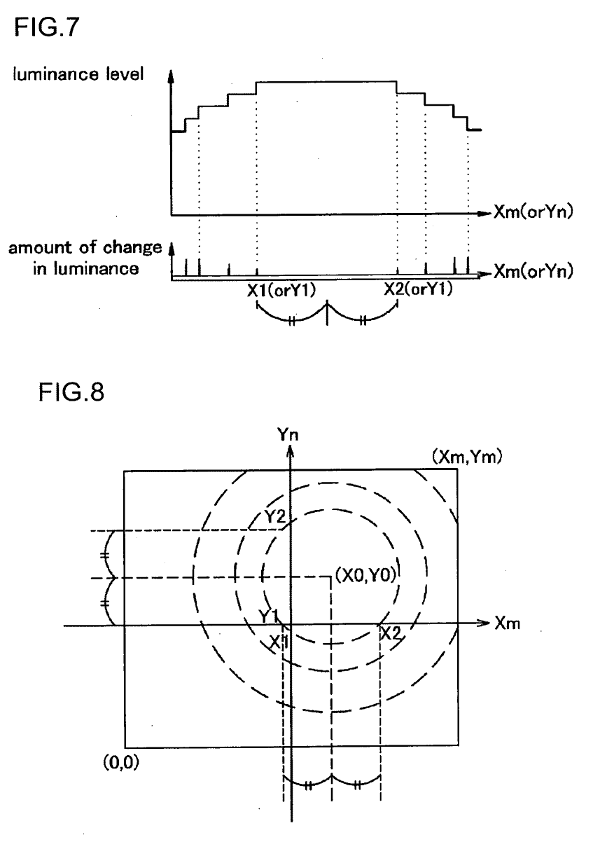

Further, in a luminance change point coordinates X1, X2 extracting process of the step S4, the horizontal shading center coordinate X extracting section 412 extracts a change point from the luminance value data of one line with a reduced resolving power (gradation) as illustrated in FIG. 6 by consecutively performing an integral process (arithmetic processing) on the luminance value data as illustrated in FIG. 7, and obtains the closest (inner-most) change point to the middle of the coordinates X1, X2 among the change points of the luminance value data.

After that, in a horizontal shading center coordinate X0 extracting process of the step S5, the center coordinate X0 of the image of change point coordinates X1, X2 is obtained by calculating the equation, X0=X1+(X2−X1)/2, using the change point coordinates X1, X2 in the middle of FIG. 7.

Similar to the steps S2 to S5 described above, the vertical shading center coordinate Y extracting section 413 extracts a vertical shading center coordinate Y0 in the step S6.

That is, in a luminance value extracting process of one line in the Y direction, the vertical shading center coordinate Y extracting section 413 extracts a luminance value of one line LY in the Y direction at the center portion in the X coordinate direction as illustrated in FIG. 4 from a digital image data from the image sensor 3 by one line in the longitudinal direction (column direction) as illustrated in FIG. 5.

Subsequently, in a luminance value resolving power lowering process, the vertical shading center coordinate Y extracting section 413 removes lower number bits (lower 2 bits or 4 bits of 256 gradient of 8 bits, herein) from 8-bit digital image data, for example, of the luminance value of one line in the Y direction in FIG. 5 to reduce the luminance value resolving power and a change of a certain width. Further, the vertical shading center coordinate Y extracting section 413 extracts a luminance value data of one line as illustrated in FIG. 6.

Further, in a luminance change point coordinates Y1, Y2 extracting process, the vertical shading center coordinate Y extracting section 413 extracts a change point from the luminance value data of one line in the Y-direction in the middle of the X direction with a reduced resolving power (gradation) as illustrated in FIG. 6 by consecutively performing an integral process (arithmetic processing) on the luminance value data as illustrated in FIG. 7, and obtains the closest (inner-most side of a concentric circle in a plan view) change point to the middle of the coordinates Y1, Y2 among the change points of the luminance value data.

After that, in a vertical shading center coordinate Y0 extracting process, the center coordinate Y0 of the image of change point coordinates Y1, Y2 is obtained by calculating the equation, Y0=Y1+(Y2−Y1)/2, using the change point coordinates Y1, Y2 in the middle of FIG. 7.

As described above, the horizontal shading center coordinate X0 is extracted by the horizontal shading center coordinate X extracting section 412, and the vertical shading center coordinate Y0 is extracted by the vertical shading center coordinate Y extracting section 413. Accordingly, the shading center coordinates (X0, Y0) of the image center is obtained as illustrated in FIG. 8. The shading correction is performed by using the shading center coordinates (X0, Y0).

As described above, in extracting the shading center coordinates (X0, Y0), an equal luminance line, which connects pixels of the equal luminance value, as illustrated with dotted lines in FIG. 8 is extracted (extracting the change point described above) from the image data from the image sensor 3, and the X coordinate and Y coordinate of the image center are defined as the shading center coordinates (X0, Y0) so as to substantially specify the center position of the image. In addition, as another set of steps different from the steps described above, for example, X0 coordinate is obtained by detecting a peak position from a mountain-shaped curve (curve in FIG. 5) obtained by plotting luminance values in a horizontal direction (X direction). Similarly, Y0 coordinate is obtained by detecting a peak position from a mountain-shaped curve (curve in FIG. 5) obtained by plotting luminance values in a vertical direction (Y direction). Defining such coordinates as the shading center position (center position of the image), the shading center coordinates (X0, Y0) can be substantially specified.

The DSP 4 is provided with the memory 42, which is configured of a nonvolatile memory circuit such as a flash memory. Therefore, the DSP 4 is able to store the shading center coordinates (X0, Y0) obtained by the steps described above even when the power is cut off.

For example, a uniform image typical of a white image is captured by the camera module 1 according to Embodiment 1 at a shipping inspection at a camera module maker. The shading center coordinates (X0, Y0) are extracted from the obtained image data by the steps described above and the coordinate data (X0, Y0) is stored in the memory 42 of the DSP 4.

In actual use by a user, the DSP 4 calls the shading center coordinates (X0, Y0) stored in the memory 42 described above in performing the shading correction, and performs the shading correction with the coordinate data (X0, Y0) as the center.

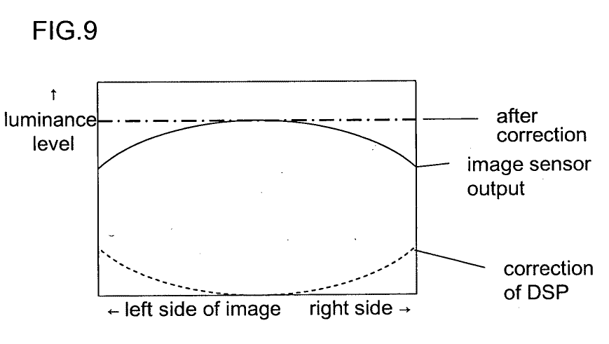

Therefore, by implementing Embodiment 1, the DSP 4 calls the shading center coordinates (X0, Y0) stored in the memory 42 described above in performing the shading correction, and performs the shading correction with the coordinate data (X0, Y0) as the center, as illustrated in a shading characteristics diagram of FIG. 9. As a result, an image data having accurately substantially uniform luminance in the overall image can be obtained even when the center of the light receiving area (image capturing area) of the image sensor 3 does not match the optical center (optical axis) of the lens 2.

In addition, by implementing Embodiment 1, the shading correction can be accurately performed in accordance with the shading center coordinates (X0, Y0) that is different in each camera module 1.

Further, by storing the shading correction coordinates in the memory 42, which is a nonvolatile memory circuit provided in the DSP 4, it will not be necessary to extract the shading center coordinates (X0, Y0) every time the power is turned on.

### Embodiment 2

In Embodiment 1 described above, the center position of the luminance value of the image is obtained as the center of the shading correction with regard to one overall image. In Embodiment 2, another case will be described, where an area of calculation is reduced by assigning, not one overall image, but a predetermined area at the middle portion of an image that includes up to and including at least the luminance change point coordinates X1, X2 and Y1, Y2.

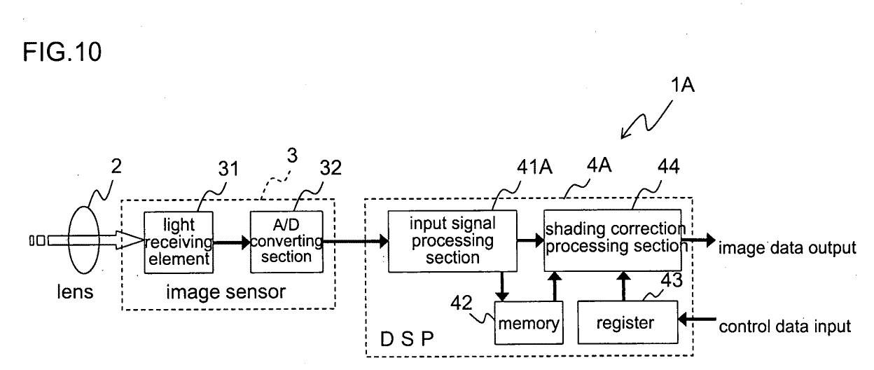

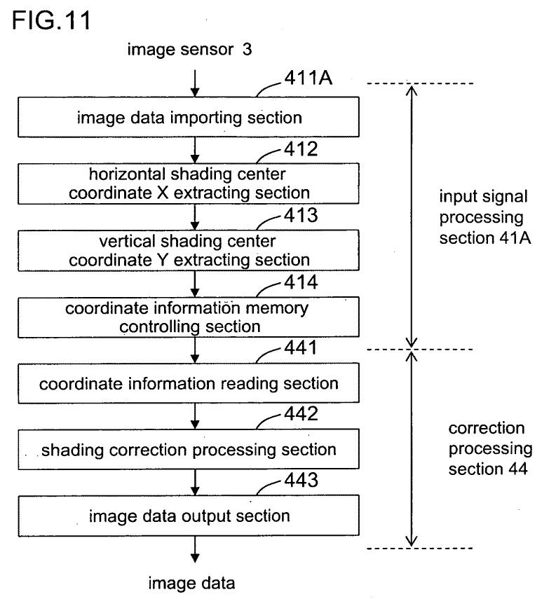

FIG. 10 is a block diagram illustrating an exemplary essential structure of a camera module according to Embodiment 2 of the present invention. FIG. 11 is a block diagram illustrating a specific structural example of an input signal processing section and a shading correction processing section in FIG. 10.

In FIG. 10, a camera module 1A according to Embodiment 2 includes: an image sensor 3 for performing a photoelectric conversion on an incident light that has passed a focusing lens 2 to form an image of an image light from a subject; and a DSP 4A functioning as a signal processing section for obtaining an image center position only for an image data of a predetermined area of an image middle portion including up to and including at least the luminance change point coordinates X1, X2 and Y1, Y2, of the image data from the image sensor 3 so as to process a shading correction.

The image sensor 3 includes: a light receiving element 31, which has an image capturing area having a plurality of light receiving sections arranged therein in a matrix for performing a photoelectric conversion on a subject light; and an A/D converting section 32 for converting an image capturing signal, which is an analog signal from the light receiving element 31, into a digital data.

The DSP 4A includes: an input signal processing section 41A for performing a predetermined arithmetic processing, using only an image data of a middle portion of a digital data (image data) from the A/D converting section 32 as an input to reduce the amount of calculations, in order to obtain the center position of an image; a memory 42 for temporarily storing the center position data of the image processed at the input signal processing section 41A; a register 43 for inputting a control data for a shading correction; and a shading correction processing section 44 for performing a shading correction process using the center position data of an image from the memory 42 and a control data for a shading correction from the register 43.

The input signal processing section 41A includes: an image data importing section 411A for importing an image data of a middle portion of one picture (a middle portion of an image including up to and including at least the luminance change point coordinates X1, X2 and Y1, Y2) of an image data of one picture from the image sensor 3; a horizontal shading center coordinate X extracting section 412 for extracting a horizontal coordinate (X coordinate) of shading center coordinates (X, Y) from the image data of the middle portion of one picture imported by the image data importing section 411A; a vertical shading center coordinate Y extracting section 413 for extracting a vertical coordinate (Y coordinate) of the shading center coordinates (X, Y); and a coordinate information memory controlling section 414 for storing each coordinate value of the shading center coordinates (X, Y), which is extracted at the horizontal shading center coordinate X extracting section 412 and vertical shading center coordinate Y extracting section 413, in the memory 42.

The shading correction processing section 44 includes: a coordinate information reading section 441 for reading out each coordinate value of shading center coordinates (X, Y) stored in the memory 42 by the coordinate information memory controlling section 414; a shading correction processing section 442 for performing a shading correction process using each coordinate value of the shading center coordinates (X, Y) from the coordinate information reading section 441; and an image data outputting section 443 for outputting an image data after the shading correction process.

With the structure described above, the operation will be described hereinafter.

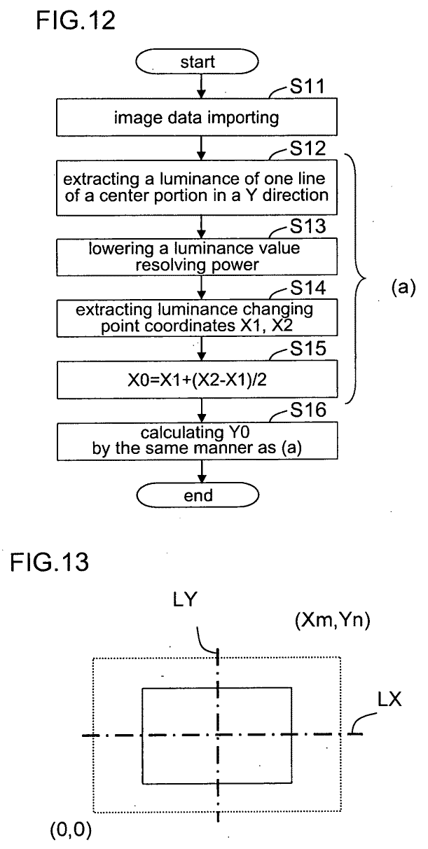

FIG. 12 is a flow chart illustrating one example of a shading center coordinate extracting process by the horizontal shading center coordinate X extracting section 412 and vertical shading center coordinate Y extracting section 413 in FIG. 11.

First, in an image importing process of the step S11, a middle portion of an image data is imported from the image sensor 3 as a predetermined middle portion of a picture of single color output image information (solid line portion of FIG. 13), of the single color output image information (dotted line portion of FIG. 13) of one picture, which starts from the coordinates (X0, Y0) to the coordinates (Xm, Ym) as illustrated in FIG. 13, the color being typically white.

Next, in a luminance value extracting process of one line in the X direction of the step S12, the horizontal shading center coordinate X extracting section 412 extracts a luminance value of one line LX in the X direction at the center portion in the Y coordinate direction as illustrated in FIG. 13 from a digital image data of the predetermined middle portion of the picture from the image sensor 3 by one line of the middle portion (solid line portion) as illustrated in FIG. 13.

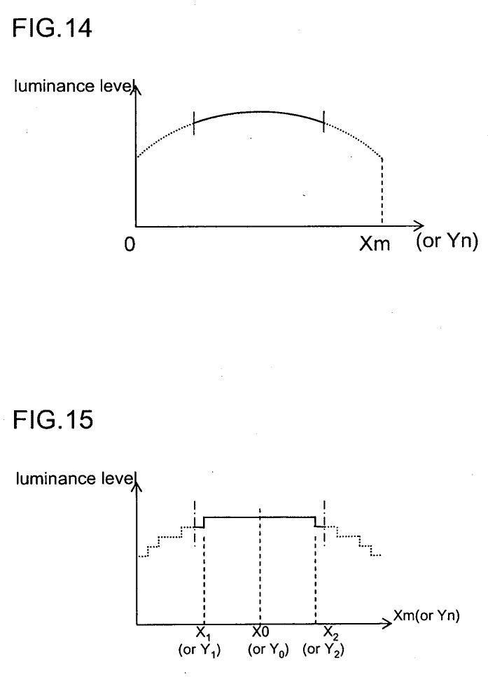

Subsequently, in a luminance value resolving power lowering process of the step S13, the horizontal shading center coordinate X extracting section 412 removes lower number bits (lower 2 bits or 4 bits of 256 gradation of 8 bits, herein) from 8-bit digital image data, for example, of the luminance value of one line in the X direction in FIG. 14 to reduce the luminance value resolving power and a change of a certain width. Further, the horizontal shading center coordinate X extracting section 412 extracts a luminance value data of one line as illustrated in FIG. 15.

Further, in a luminance change point coordinates X1, X2 extracting process of the step S14, the horizontal shading center coordinate X extracting section 412 extracts a change point from the luminance value data of one line of the middle portion with a reduced resolving power (gradation) as illustrated in FIG. 15 by consecutively performing an integral process (arithmetic processing) on the luminance value data, and obtains the closest (inner-most) change point to the middle of coordinates X1, X2 among the change points of the luminance value data. That is, the single color output image information (solid line portion of FIG. 13) of a predetermined middle portion of the picture is imported in such a manner to include the change point coordinates X1 and X2.

After that, in a horizontal shading center coordinate X0 extracting process of the step S15, the center coordinate X0 of the image of change point coordinates X1, X2 is obtained by calculating the equation, X0=X1+(X2−X1)/2, using the change point coordinates X1, X2 where the luminance level is the highest in the coordinate range.

Similar to the steps S12 to S15 described above, the vertical shading center coordinate Y extracting section 413 extracts a vertical shading center coordinate Y0 in the step S16.

According to Embodiment 2 as described above, when obtaining the center position of the image, the area of calculation is reduced, and as a result, the amount of calculations can be significantly reduced.

### Embodiment 3

In Embodiments 1 and 2, a case has been described where the center position of an image is obtained in performing a shading correction of a luminance value and the shading correction is performed using the center position as a shading center coordinates. In Embodiment 3, a case will be described where a color shading correction is performed for a decrease in the level (decrease of the amount of light) of only the color red (R) among three primary colors (R, G and B) at a peripheral portion in a picture when an infrared ray (IR) cut filter is used.

Using shading center coordinates (X, Y) as center position information of an image stored in the memory 42 of FIG. 1 or 10, a red color shading correction is performed only on a signal level of a red color data such that the signal level of the red color data matches the signal level of other green color data and blue color data in an overall picture. In this case, the red color shading correction may be performed after the three primary colors become complete after a color signal interpolating process of a variety of digital signal processes.

In addition, the shading correction for the luminance value according to Embodiment 1 or 2 and the color shading correction of the red color according to Embodiment 3 may be performed together.

### Embodiment 4

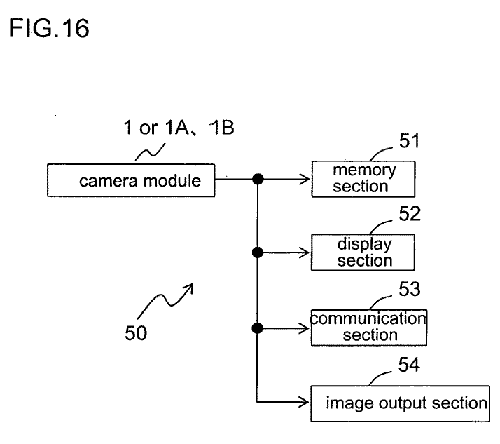

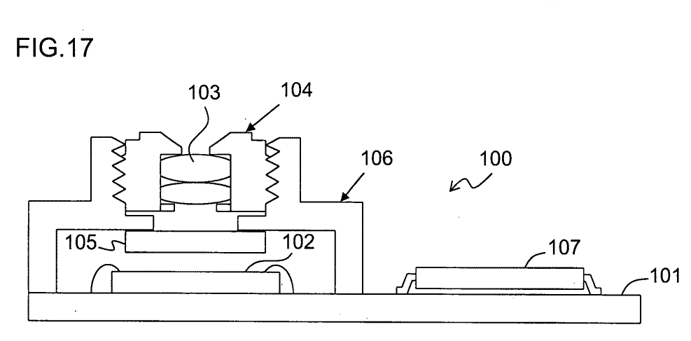

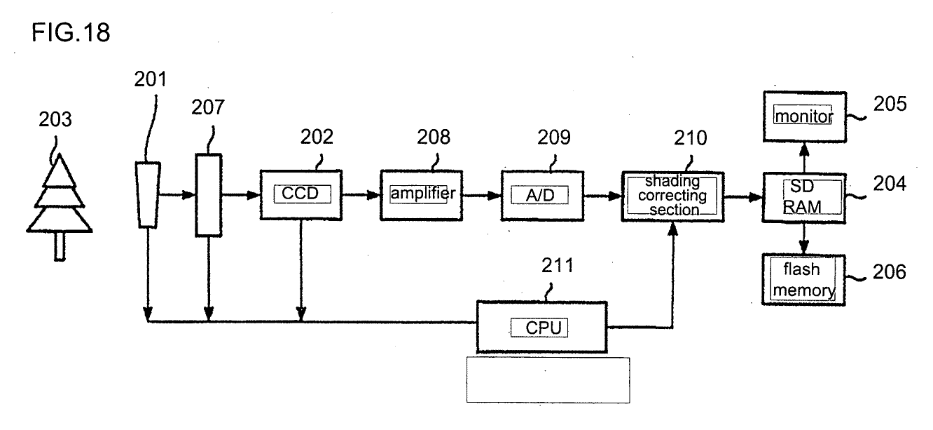

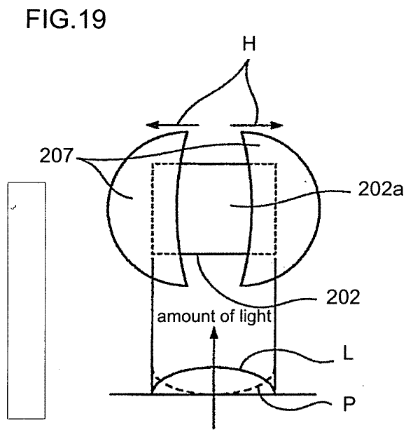

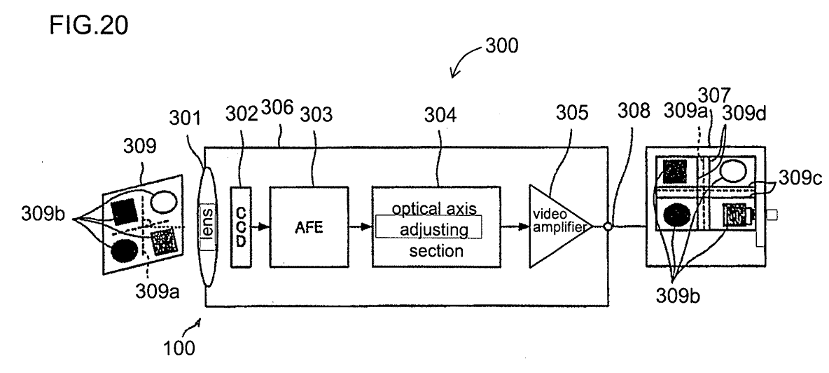

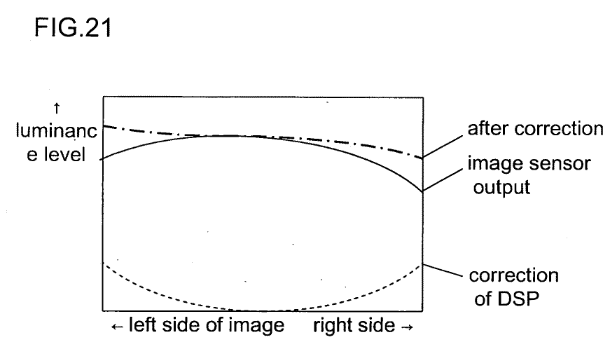

FIG. 16 is a block diagram illustrating an exemplary diagrammatic structure of an electronic information device as Embodiment 4 of the present invention, having the camera module according to any of Embodiments 1 to 3 of the present invention as an image input device used in an image capturing section thereof.

In FIG. 16, the electronic information device 50 according to Embodiment 4 of the present invention includes: the camera modules 1, 1A or 1B (camera module 1B according to Embodiment 3) according to any of Embodiments 1 to 3 described above; a memory section 51 (e.g., recording media) for data-recording a color image signal from the camera modules 1, 1A or 1B after a predetermined signal process is performed on the color image signal for recording; a display section 52 (e.g., a color liquid crystal display apparatus) for displaying the color image signal from any of the camera modules 1, 1A and 1B on a display screen (e.g., liquid crystal display screen) after a predetermined signal processing is performed on the color image signal for display; and a communication section 53 (e.g., a transmitting and receiving device) for communicating the color image signal from any of the camera modules 1, 1A and 1B after predetermined signal processing is performed on the color image signal for communication

An electronic information device that has an image input device is conceivable, as the electronic information device 50, such as a digital camera (e.g., digital video camera and digital still camera), an image input camera (e.g., a monitoring camera, a door phone camera, a camera equipped in a vehicle (e.g., a camera for monitoring back view), and a television telephone camera), a scanner, a facsimile machine and a camera-equipped cell phone device.

Therefore, according to Embodiment 4 of the present invention, the color image signal from the camera module 1, 1A or 1B can be: displayed on a display screen finely; printed out on a sheet of paper using an image output section 54; communicated finely as communication data via a wire or a radio; and stored finely at the memory section 51 by performing predetermined data compression processing, and various data processes can be finely performed. Thus, the electronic information device 50 may include at least any of the memory section 51, the display section 52, the communication section 53, and the image output section 54.

According to Embodiments 1 to 3 as described above, the camera module 1, 1A or 1B includes: a light receiving element 31 for capturing an image of a subject via an optical lens 2; and a DSP 4 functioning as a signal processing section for obtaining image center position information with respect to a digital data A/D converted from an image data from the light receiving element 31 to process a shading correction using the image center position information as shading correction center position information. As a result, the shading correction can be performed at the center of the image. As described above, the image center position information is obtained for the image data from the light receiving element 31 to process the shading correction, so that it is no longer required to adjust an optical axis by an optical chart as performed conventionally. Further, no improvement is required on the accuracy for correcting deviation of a center of an optical axis due to the assembling, and a finer image with the shading correction can be obtained.

In addition, although not specifically described in Embodiment 1, the camera module 1, 1A or 1B includes: an image capturing section for capturing an image of a subject via an optical system; and a signal processing section for processing a shading correction by obtaining image center position information for an image data from the image capturing section. As a result, the objective of the present invention, where no improvement is required on the accuracy for correcting deviation of a center of an optical axis due to the assembling and a finer image with the shading correction can be obtained, can be achieved.

As described above, the present invention is exemplified by the use of its preferred Embodiments 1 to 4. However, the present invention should not be interpreted solely based on Embodiments 1 to 4 described above. It is understood that the scope of the present invention should be interpreted solely based on the claims. It is also understood that those skilled in the art can implement equivalent scope of technology, based on the description of the present invention and common knowledge from the description of the detailed preferred Embodiments 1 to 4 of the present invention. Furthermore, it is understood that any patent, any patent application and any references cited in the present specification should be incorporated by reference in the present specification in the same manner as the contents are specifically described therein.

### INDUSTRIAL APPLICABILITY

The present invention can be applied in the field of an image capturing apparatus, such as a camera module, for performing a photoelectric conversion on and capturing an image light from a subject, and an electronic information device, such as a digital camera (e.g., digital video camera and digital still camera), an image input camera (e.g., car-mounted back view camera), a scanner, a facsimile machine, and a camera-equipped cell phone device, having the image capturing apparatus as an image input device used in an image capturing section thereof. According to the present invention as described above, the shading correction is processed by obtaining image center position information with regard to an image data from the image capturing section, and therefore, no improvement is required on the accuracy for correcting deviation of a center of an optical axis due to the assembling, and a finer image with the shading correction can be obtained.

Various other modifications will be apparent to and can be readily made by those skilled in the art without departing from the scope and spirit of this invention. Accordingly, it is not intended that the scope of the claims appended hereto be limited to the description as set forth herein, but rather that the claims be broadly construed.

What is claimed is:

1. An image capturing apparatus, comprising:
an image capturing section for forming an image of a subject via an optical system; and
a signal processing section for obtaining image center position information for image data from the image capturing section to perform a shading correction.

2. An image capturing apparatus according to claim 1, further comprising:
an image center position information extracting section for importing an image data from the image capturing section to obtain the image center position information; and
a shading correcting section for performing a shading correction process using the image center position information as shading center position information so that the amount of light does not decrease at a peripheral portion of a captured image.

3. An image capturing apparatus according to claim 1, wherein:
the image capturing section is attached to a substrate;
a lens holder, to which a focusing lens of the optical system is attached, accommodates the image capturing section inside and is attached to the substrate;
and the signal processing section is attached near the lens holder on the substrate.

4. An image capturing apparatus according to claim 3, wherein an infrared ray cut filter for cutting infrared rays from incident light from the focusing lens is positioned across the image capturing section and the focusing lens.

5. An image capturing apparatus according to claim 1, wherein the image capturing section is a light receiving section, which has an image capturing area having a plurality of light receiving sections arranged therein in a matrix for performing a photoelectric conversion on a subject light.

6. An image capturing apparatus according to claim 1, wherein the image capturing apparatus is provided with an A/D converting section for converting an analog image capturing signal from the light receiving section to a digital data, and the digital data from the A/D converting section is used as the image data to extract the image center position information.

7. An image capturing apparatus according to claim 2, wherein the image center position extracting section includes:
an image data importing section for importing an image data from the image capturing section;
a horizontal center coordinate extracting section for extracting a horizontal center coordinate of the image center position information from an image data imported by the image data importing section; and
a vertical center coordinate extracting section for extracting a vertical center coordinate of the image center position information from the image data imported by the image data importing section.

8. An image capturing apparatus according to claim 7, wherein the image center position information extracting section further includes a coordinate information memory controlling section for storing a coordinate value of each center coordinate extracted from the horizontal center coordinate extracting section and the vertical center coordinate extracting section, in a storing section as the image center position information.

9. An image capturing apparatus according to claim 7, wherein the image data importing section imports a data of an overall picture or a middle portion of the picture of an image data from the image capturing section.

10. An image capturing apparatus according to claim 9, wherein the middle portion of the image of the image data is an image middle area, which includes at least two inner-most luminance change point coordinates of an X direction and a Y direction when a resolving power of a luminance value is lowered for one line of each picture in the X direction and the Y direction.

11. An image capturing apparatus according to claim 7, wherein each of the horizontal center coordinate extracting section and the vertical center coordinate extracting section includes:
a luminance value extracting process section for extracting a luminance value of one line of a picture;
a luminance value resolving power lowering process section for lowering a resolving power of the extracted luminance value of one line in a picture;
a luminance changing point extracting process section for extracting two inner-most luminance changing point coordinates of the luminance value of one line in a picture; and
a shading center coordinate extracting process section for extracting the center coordinates of the two inner-most luminance changing point coordinates as a shading center coordinates.

12. An image capturing apparatus according to claim 11, wherein the luminance value extracting process section extracts, from a digital image data from the image capturing section, a luminance value of one line in a X direction at a center portion in a Y coordinate direction as well as a luminance value of one line in a Y direction at a center portion in an X coordinate direction.

13. An image capturing apparatus according to claim 11, wherein the luminance value resolving power lowering process extracts a luminance value data of one line in an X direction, where a predetermined lower number of bits are removed from a digital image data of the luminance value of one line in the X direction and the luminance value resolving power is reduced, and a luminance value data of one line in a Y direction, where a predetermined lower number of bits are removed from a digital image data of the luminance value of one line in the Y direction and the luminance value resolving power is reduced.

14. An image capturing apparatus according to claim 11, wherein the luminance changing point extracting process section consecutively performs an integral process on a luminance value data of one line having a reduced luminance value resolving power so as to extract changing points, and obtains two inner-most changing point coordinates of changing points of the luminance value data.

15. An image capturing apparatus according to claim 11, wherein the shading center coordinate extracting process section obtains center coordinates of an image, X0 and Y0, of changing point coordinates X1, X2 and Y1, Y2 from equations X0=X1+(X2−X1)/2 and Y0=Y1+(Y2−Y1)/2, using the two inner-most changing point coordinates, X1, X2 and Y1, Y2.

16. An image capturing apparatus according to claim 8, wherein the shading correction processing section includes:
a coordinate information reading section for reading out each coordinate value of image center position information stored in the storing section;
a shading correction processing section for performing a shading correction process using each coordinate value of the image center position information from the coordinate information reading section; and
an image data outputting section for outputting an image data after the shading correction process.

17. An image capturing apparatus according to claim 2, wherein the shading correcting process is at least either a luminance shading correcting process or a color shading correcting process.

18. An image capturing apparatus according to claim 2, wherein the image center position information extracting section detects optical axis center position information from an even image data from the image capturing section as the image center position information.

19. An image capturing apparatus according to claim 3, wherein the image capturing apparatus is a camera module.

20. An electronic information device having the image capturing apparatus according to claim 1 used as an image input device in an image capturing section.
